(19) United States
(12) Patent Application Publication
(10) Pub. No.: US 2004/0078371 A1
(43) Pub. Date: Apr. 22, 2004

(54) Method and system for providing multiple virtual portals on a computer network

(76) Inventors: Joel Worrall, Grantham, PA (US); William Kratzer, Harrisburg, PA (US); Andrew Libby, Mechanicsburg, PA (US); Terry Johnson, State College, PA (US)

Correspondence Address: Marc J. Farrell, REEDSMITH LLP, 9th Floor, 213 Market Street, Harrisburg, PA, 17101-2108, US

(21) Appl. No.: 10/445,726

(22) Filed: May 22, 2003

Related U.S. Application Data
(60) Provisional application No. 60/382,352, filed on May 22, 2002.

(51) Int. Cl. G06F 17/30

(52) U.S. Cl. 707/9

(57) ABSTRACT

A method and system of managing data for a plurality of users is disclosed. The method and system include a maintaining, in a computer memory, of a plurality of databases that each comprise user access data, a providing of at least one network portal supported by a plurality of virtual hosts, a receiving of a user identification from at least one of the plurality of users, a selecting, based on the received user identification, from the plurality of virtual hosts, of a selected virtual host to uniquely present the portal to the user, and an identifying, in accordance with the selected virtual host, from the plurality of databases, of at least one authorized database accessible to the user.

### CROSS-REFERENCE TO RELATED APPLICATIONS

This application claims priority to a U.S. Provisional Patent Application entitled “Method and System for Supporting Multiple Virtual Portals on a Computer Network”, filed on May 22, 2002, which is incorporated herein by reference as if set forth in its entirety.

### FIELD OF THE INVENTION

The present invention generally relates to methods and systems for providing portals to accessing a communications network. More particularly, the present invention relates to an efficient method and system for supporting multiple portals while managing access to separate data sources, configuration, and appearance associated with each portal.

### BACKGROUND ON THE INVENTION

A portal, also known as a gateway, is a software application that provides a focused access point by which a user can access a communications network. The term “portal” is most commonly used in connection with the Internet for a World Wide Web site that serves as a major starting point for users when they connect to the Web. Portal sites may provide several services for Internet users, such as a search engine, a directory of Web sites, news and weather information, e-mail, stock quotes, links to chat room and shopping opportunities, directories such as phone and geographic directories, and other services. Some common general portals include Yahoo, America Online's AOL.com, Excite, and Lycos. Many Internet service providers and companies offer their own branded portals to the Web for users of their Internet services. Portal sites allow the service provider to achieve large audiences and focus targeted messages, such as advertising. messages, corporate information, and other desired information, to the users each time they access the Web using the portal,

In many cases, service providers, corporations, and other entities need to deploy multiple portals. Through multiple portals, a service provider can present users or groups of users with customized portals, each with their own databases, authentication sources, and appearance. Therefore, the entity can maintain security and manage data such that a first portal cannot be accessed by users of a second portal, and vice versa.

To date, service providers who desired to provide multiple portals were required to install a separate instance of Portal creation/support software for each portal, The problems associated with the approach are many, including the large disk space and memory requirements associated with installing multiple instances of software, along with the increased computer processing capacity required to run multiple instances of software. These problems result in very high costs for a service provider or other user who desires to provide multiple portals.

Accordingly, it is desirable to provide a novel method and system for deploying multiple computer network portals as described herein.

### SUMMARY OF THE INVENTION

In accordance with a preferred embodiment of the invention, a method of managing data for multiple users includes the steps of: maintaining, in a computer program memory, a plurality of databases containing user data; providing a network portal that may be supported by a plurality of virtual hosts; supporting the portal with the plurality of virtual hosts; receiving a user identification in accordance with the user data; selecting, via at least one central application, based on the user identification, from the plurality of virtual hosts, a selected virtual host to support a presentation of the portal to the user; and identifying, via the central application, from the plurality of databases, one or more authorized databases that may be accessed by the user. Optionally, a user interface templating engine may be provided, whereby a user may modify, via templates, common interface components, such as a portal header, a portal footer, a portlet header, a portlet footer, a login screen, a system error screen, a paging user interface, and the like. Optionally, the identifying is performed based on the user identification and/or a role that is associated with the user. Also optionally, the user identification may comprise a network address, The method may also include the step of authorizing the user to access one or more applications.

In accordance with an alternate embodiment, a networked data management system includes a plurality of databases, a plurality of virtual portal hosts, and a central support layer that is in communication with each of the virtual portal hosts and each of the databases. The central support layer includes computer program instructions that instruct a processor to receive an identification that is associated with a user, select a selected virtual portal host based on the identification, present a portal to the user whereby the selected virtual portal host supports the portal, and identify one or more databases from the plurality of databases for which the user will be authorized to access

In accordance with another embodiment, a data management system supporting multiple users, includes a carrier containing program instructions that: (1) support a data structure comprising a plurality of databases; (2) support a plurality of virtual hosts configured to provide a portal to a user; and (3) select one of the virtual hosts and at least one of the databases that corresponds to the user.

### BRIEF DESCRIPTION OF THE DRAWINGS

The invention will be better understood with reference to the following illustrative and non-limiting drawings, in which like references there-throughout designate like elements of the invention, and wherein:

FIG. 1 is a block diagram that illustrates a preferred embodiment of the inventive concept of supporting several virtual hosts/portals and several databases using a single core software application.

FIG. 2 is a block diagram that illustrates a preferred embodiment of the software architecture associated with the present invention.

FIG. 3 is a block diagram that further illustrates a preferred embodiment of the software architecture associated with the present invention.

FIG. 4 illustrates an exemplary computer of a type suitable for carrying out the functions of the present invention.

FIG. 5 illustrates several elements of a preferred embodiment of the computer illustrated in FIG. 4.

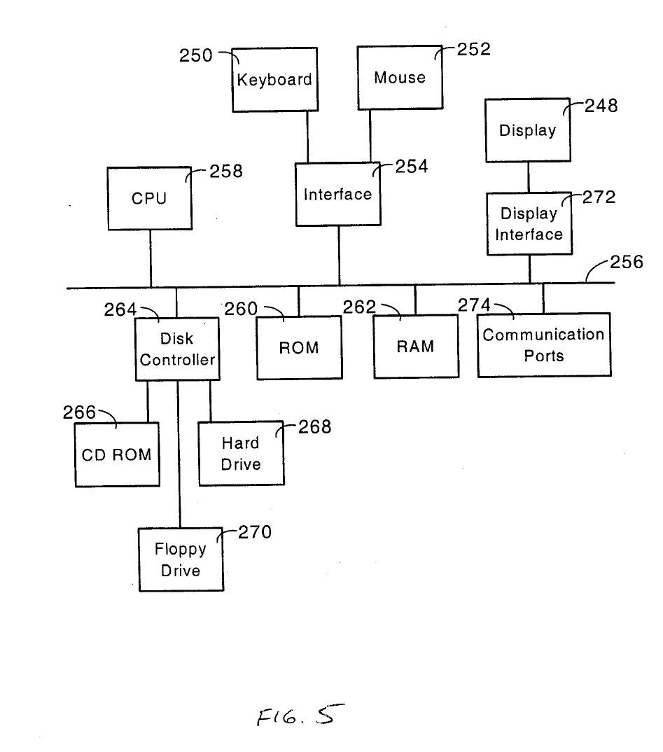

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in a typical software and routing system and method. Those of ordinary skill in the art will recognize that other elements are desirable and/or required in order to implement the present invention. However, because such elements are well known in the art, and because they do not facilitate a better understanding of the present invention, a discussion of such elements is not provided herein.

An embodiment of the present invention provides a method and system for deploying multiple computer network portals. In an embodiment, a Java-based application provides traditional and non-traditional service providers with a robust portal platform to provide a solution that is high scalable yet highly functional, this platform is designed to follow a concept referred to herein as “virtual instances” of the application.

In an embodiment, the present invention provides multiple Web site portals to users of the Internet. The present invention also encompasses non-Web based and non-Internet based portals, such as portals to an intranet, portals to a wireless communications network, portals to a broadcast network, and other systems for accessing other types of communications, as will be apparent to one skilled in the art. In addition to the exemplary Java-based application mentioned herein above, one skilled in the art will recognize that other programming languages and methodologies, such as C++, XML, or .NET,. for example, may be used.

Virtualization can be defined by considering multiple virtual network sites. Each site is preferably a unique “instance” of a portal user interface, coupled with a distinct data storage, such as a database. Thus, many users may access a network site by typing the same network address into their respective browsers, but the system services different groups of users using different “virtual hosts”, thereby providing a presentation of different content and functionality to each group based on the host or hosts that are uniquely assigned to each different group.

Each user who logs into a virtual site may access that virtual site through a unique uniform resource locator (URL) or other type of address. Based on the user's URL or other address of interest, the system may determine which virtual host should be used to support that user's access to the site. The content of the site, as presented to the user, is dependent upon the virtual host that is assigned to that user. In addition, each virtual host may be associated with one or more databases, and the system additionally determines what database or databases may be accessed by the user in accordance with the virtual host selected. If a particular database is not associated with the user's selected virtual host, then preferably the user is not given permission to access that database. This selection and presentation process is not evident to the user, as multiple virtual sites may be supported as part of a single instance of the software application.

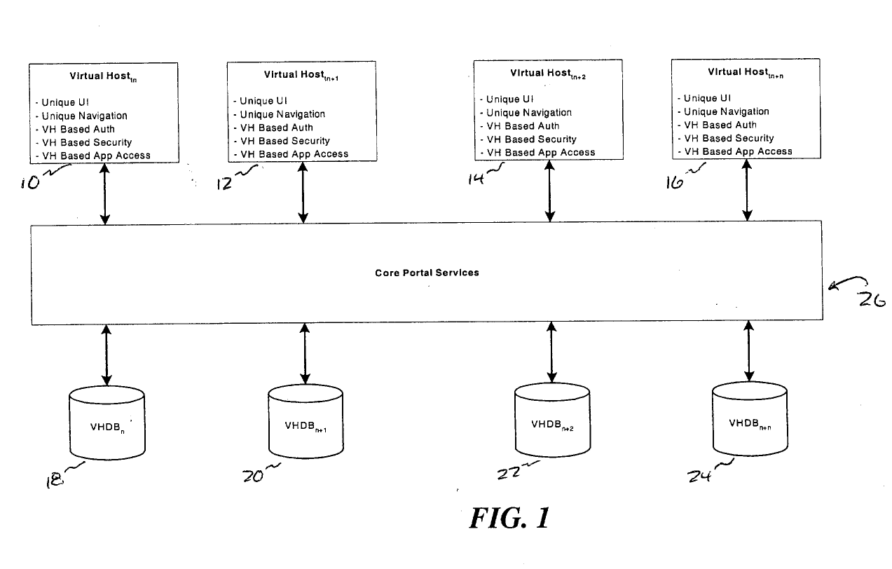

FIG. 1 illustrates the supporting of several virtual hosts/portals, and several databases, by a single core software application. Referring to FIG. 1, several virtual hosts 10, 12, 14, and 16 and several databases 18, 20, 22, and 24 are shown. A common portal service infrastructure 26 may link each component. Each virtual host is capable of accessing and leveraging components made available via the portal's core infrastructure. The number of virtual hosts and databases shown in FIG. 1 is illustrative, and any number of hosts and databases may be supported by the core infrastructure 26.

Users logging into a virtual site may access it first through a unique URL. When logging into the system, users may preferably validate against the information stored for the virtual site correspondent to that user only. The branding of the application will be specific to the site, and even the navigation through screens may be customized, as alluded to hereinabove. IN part, this customization may be provided by a user interface templating engine, whereby a user may modify, via templates, common interface components, such as a portal header, a portal footer, a portlet header, a portlet footer, a login screen, a system error screen, a paging user interface, and the like, at the virtual host level. This allows, for example, graphic designers to vary the “look and feel” of a virtual host site by simplistically modifying tenmplates per virtual host. Further, an authentication framework may allow different virtual sites to authenticate using different authentication schemes.

Each validated User may contain a model manager that supplies access to infrastructure models. The model manager, and the models that it accesses, may be persisted in a standard http session, but for the purposes of creating separation, the http session may not be accessed directly but rather may be the silent storage of the model manager. The model manager may contain several models, as discussed further hereinbelow, each having the responsibility of pulling and caching necessary data, as well as updating its data to the persistence. Models may include, for example, StyleModel, DesktopModel, VirtualizationModel, ConfigurationModel, AssociatedGroupModel, UserModel, SecurityModel, AuthenticationModel, and/or TransactionModel. Each model may maintain a separate responsibility utilized by either the upper layer controller or the lower level persistence. Thereby, models may handle often accessed data, such as Style Preferences, the logged in User, security information, and/or a desktop layout, for example, but may not access all application data, thus increasing efficiencies.

In these exemplary models, the UserModel class may be responsible for pulling the authenticated user object, based on the username of the authenticated account in the AuthenticationModel. Updates to the personal information interface may push changes through the UserModel. The AssociatedGroupModel may handle caching and updating group associations for the current authenticated account within the given http session.

The NavigationModel, which may be stored in the servlet context, may look to an administrative data source to search for the navigation records that exist for this session's virtual host or all virtual hosts, allowing for different navigation patterns for different virtual hosts. The VirtualizationModel may hold the virtual host instance to whomever the given session belongs, and may provide access to the data sources associated to that virtual host based on the registration of data source instances with DataSourceManager in the servlet context.

The DataSourceManager may maintain the list of data source instances that correspond to the DatabaseConfig records in the persistence. On launch, the DataSourceManager starts up, queries persistence for the DatabaseConfig instances, and instantiates a data source for each DatabaseConfig. Among the information on a DatabaseConfig instance is a recognition of the virtual host to which it is tied, and a flag that determines what is the default data source for the given virtual host.

The AuthenticationModel may act as the entry point to an authentication framework. It may contain login and logout methods that make requests of authentication services for determining whether an account can be authenticated on behalf of a requesting session. The ConfigurationModel may exists in ModelManager, but may not reside in the http session. It represents configuration parameters associated to a particular virtual host. Therefore, replicating the ConfiguartionModel information in every session is not practical or useful.

Some exemplary model classes for use in the present invention are given in Table A.

TABLE A

| Class Name | Description |
|---|---|
| Com.commnav.sbh.framework.persist.ConnectionProxy | Implements the java.sgl.Connection |
| | interface and wraps a legitimate |
| | Connection implementation to provide |
| | ConnectionPooling services |
| | transparently. |
| Com.commnav.sbh.framework.persist.ClassDatabaseConfigAssociation | Associates a Java class to a |
| | DatabaseConfig instance. |
| Com.commnav.sbh.framework.persist.ConversionEngineFactory | Has the job of building new |
| | ConversionEngine implementations. |
| Com.commnav.sbh.framework.persist.DatabaseConfig | Business object stores the information |
| | necessary to build an SBHDataSource, |
| | Complete with the Connection |
| | information and pooling parameters. |
| Com.commnav.sbh.framework.persist.DatasourceEngineFactory | Has the job of building new |
| | DatasourceEngine implementations. |
| Com.commnav.sbh.framework.persist.SBHDataSource | Implements the javax.sgl.DataSource |
| | interface, subclasses the ObjectPool |
| | abstract class, and maintains the pool |
| | of Connections. |
| Com.commnav.sbh.framework.persist.SBHDataSourceManager | Maintains a hash of SBHDatasource |
| | instances and provides methods for |
| | pulling those DataSources based on the |
| | Virtual Host and a class name. |
| Com.commnav.sbh.framework.persist.TransactionModel | Subclass of Model keeps track of the |
| | Connections associated with a |
| | transaction as well as the state of the |
| | transaction. Allows atomic commits |
| | and rollbacks. |
| Com.commnav.sbh.framework.persist.TransacdonDataSource | javax.sgl.DataSource implementation |
| | wraps the SBHDataSource class and |
| | provides Transaction support by |
| | overriding the Connection.close |
| | method and storing the Connections in |
| | the TransactionModel for the given |
| | User. |
| com.commnav.sbh.framework.authentication.AuthenticationExcepfon | Subclass of CommnavException for |
| | Authentication system exceptions. |
| com.commnav.sbh.framework.authentication.AuthenticationModel | Subclass of Model handles calling the |
| | classes of the authentication system |
| | and tracks the authentication status of |
| | the current Session User. |
| com.commnav.sbh.framework.authentication.AuthenticationService | Interface provides a common set of |
| | methods for setting the proper |
| | parameters for an authentication |
| | process and the authenticate method to |
| | perform the actual process. |
| com.commnav.sbh.framework.authentication.AuthenticationServiceFactory | Factory class generates |
| | implementations of |
| | AuthenticationService. |
| com.commnav.sbh.framework.authentication.AuthenticationToken | Interface represents the product of |
| | valid authentication process. Provides |
| | one simple method for returning |
| | whether or not the authentication was |
| | successful. |
| com.commnav.sbh.framework.authentication.CheckAuthenticationTag | JSP Tag that checks the is |
| | Authenticated method in the |
| | AuthenticationModel in a |
| | ModelManager in the HttpSession. |
| com.commnav.sbh.framework.authentication.DefaultAuthenticationSeNICe | Default AuthenticationService |
| | implementation that requires a |
| | username and password. |
| com.commnav.sbh.framework.authentication.LoginModuleFactory | The Factory class that generates |
| | LoginModule instances, used by the |
| | DefaultAuthenticationService. |
| com.commnav.sbh.framework.authentication.LoginModule | Interface that performs the Login |
| | based on a username and password. |
| com.commnav.sbh.framework.authentication.DefaultLoginModule | Default implementation of the |
| | LoginModule interface that validates a |
| | login based on the username and |
| | password against the default |
| | DataSource for a Virtual Host. |
| com.commnav.sbh.framework.authentication.LoginTag | JSP Tag that executes the login |
| | business logic through the |
| | AuthenticationModel. |
| com.commnav.sbh.framework.authentication.LogoutTag | JSP Tag that executes the logout |
| | business logic through the |
| | AuthenticationModel. |
| com.commnav.sbh.framework.config.Configuration | Interface that allows access to |
| | configuration parameters based on key/ |
| | value pairs. |
| Com.commnav.sbh.framework.config.Configuration Manager | Manages Configuration parameters for |
| | each of the Virtual Host. |
| Com.commnav.sbh.framework.config.ConfigurationModeI | Model subclass that implements |
| | Configuration interface and gives |
| | access to the ConfigurationParameter |
| | objects in the ConfigurationManager. |
| Com.commnav.sbh.framework.config.ServletConfigConfiguration | Configuration implementation that |
| | uses the javax.servletServletConfig as |
| | backend store for configuration |
| | parameters. |
| Com.commnav.sbh.framework.config.StaticConfigurabon | Singleton class that provides access to |
| | a Configuration implementation |
| | instance as setup by the init method of |
| | the ControlServlet. This is a temporary |
| | class that should be used rarely if ever. |
| Com.commnav.sbh.framework.logging.DBLogHandler | Implements the |
| | java.util.logging.Handler interface to |
| | write LogRecords to the SBH |
| | database, along with searching for the |
| | VirtualHost and User in the alternative |
| | parameters of the LogRecord. |
| Com.commnav.sbh.framework.logging.LoggingModel | Model subclass retrieves the |
| | java.utii.logging.Logger |
| | implementation specific to the session's |
| | Virtual Host. |
| Com.commnav.sbh.framework.logging.SBHLogger | Wraps and implements |
| | java.util.logging.Logger to ensure that |
| | the User and VirtualHost instances for a |
| | given session appear in all LogRecords. |
| Com.commnav.sbh.framework.model.ModelManager. | Class stored in the HttpSession that |
| | provides easier standard, none web-tier |
| | access to the implementations of Model |
| | through the system. Set in the |
| | authenticated User and available |
| | through the layers of the system. |
| Com.commnav.sbh.framework.model.UserModel | Model subclass that provides access to |
| | the User object that results from the |
| | authentication of an account in the |
| | SBH. |
| Com.commnav.sbh.framework.model.AssociatedGroupModel | Model subclass that provides retrieval |
| | and update methods for handling |
| | associated group updates. |
| Com.commnav.sbh.framework.model.Model | Abstract class that provides helper |
| | methods for persisting Serialized |
| | objects to the HttpSession associated |
| | with a Model subclass. |
| Com.commnav.sbh.framework.navigation.NavigabonModel | Stored in Servlet Context, in allows |
| | access to the navigation logic system, |
| | searching for Navigation Records based |
| | on VirtualHost and control action |
| | request variable value. |
| Com.commnav.sbh.framework.security.SecudtyModel | Model subclass that caches |
| | SecurityModel searches, updates cache |
| | by the Persistenco Object infrastructure. |
| com.commnav.sbh.framework.virtualizabon.VirtualHost | Resource implementation that contains |
| | the basic information necessary for |
| | establishing and maintaining a virtual |
| | site. |
| com.commnav.sbh.framework.virtualization.VHConfigParameter | Resource implementation that stores |
| | key value pairs of configuration |
| | information for a Virtual Host. Used by |
| | the ConfigurationManager to provide |
| | Configuration parameters to a Virtual |
| | Host. |
| com.commnav.sbh.framework.virtualization.VirtualHostmanager | On start up of the ControlServlet, loads |
| | and keeps track of all Virtual Hosts in |
| | the SBH |
| com.commnav.sbh.framework.virtualizabon.VirtualizabonModel | Model subclass that provides access to |
| | the Virtual Host and its registered |
| | DataSources. |
| com.commnav.sbh.applications.desktop.DesktopModel | Model subclass that handles a User's |
| | desktop layout, both retrieval and |
| | updates. Contains initial hooks for |
| | supporting multiple desktops. |
| com.commnav.sbh.applications.desktop.LayoutManager | Performs the actual persistence updates |
| | of PidgetInstances and layouts. |
| com.commnav.sbh.applications.desktop.DesktopColumnSetTag | JSP Tag and CollectionTag |
| | implementation that provides access to |
| | the columns of a Desktop's layout. |
| com.commnav.sbh.applications.desktop.DesktopRowListTag | JSP Tag and Collection Tag |
| | implementation that provides access to |
| | the rows within a column of a |
| | Desktop's layout. |
| com.commnav.sbh.applications.desktop.LayoutKeys | Interface of static constants used for the |
| | desktop JSP's and layout administration |
| | pages. |
| com.commnav.sbh.applications.desktop.DesktopLoadTag | JSP Tag that loads a specific layout for |
| | a specific Desktop. |
| com.commnav.sbh.applications.adminsitration.styleeditor.StyleModel | Model subclass that handles a User's |
| | style Preferences, both retrieval and |
| | updates. |
| com.commnav.sbh.applciations.administration.styleeditor.StyleManager | Performs the actual persistence updates |
| | of Style Preferences. |
| com.commnav.sbh.applications.administration.styleeditor.StylePreferenceLoadTag | JSP Tag that loads the style Preferences |
| | for the Accessor specified. |
| Com.commnav.sbh.applications.administration.styleeditor.StylePreferenceTag | JSP Tag that accessess a style |
| | Preference. |
| com.commnav.sbh.applications.adminsitration.styleeditor.StylePreferenceKeys | Interface of static constants used for the |
| | style administration and display JSP's. |
| com.commnav.sbh.objects.Desktop | Resource implementation that |
| | represents an SBH Desktop. Not |
| | currently use, but built for future |
| | multiple-desktop support. |
| com.commnav.sbh.tags.CollectionTag | JSP Tag interface extending |
| | javax.servlet.jsp.tagext.Tag that |
| | specifies access to a Collection. |
| com.commnav.sbh.tags.CommnavJspExceptionTag | JSP Tag implementing |
| | javax.servlet.jsp.tagext.TryCatchFinally |
| | interface to be the exception handling |
| | tag for all SBH JSP's. |
| Com.commnav.sbh.util.ErrorIDGenerator | Abstract class built for the Commnav |
| | Exception structure that generates an |
| | error id. |
| Com.commnav.sbh.util.SequenceErrorIDGenerator | Default ErrorIDGenerator |
| | implementation that generates the error |
| | ID from a sequence statement specified |
| | in the Configuration implementation of |
| | the StaticConfiguration. |
| Com.commnav.sbh.util.WebKeys | Interface of static constants used in the |
| | Servlets, HttpSession, and JSP's. |

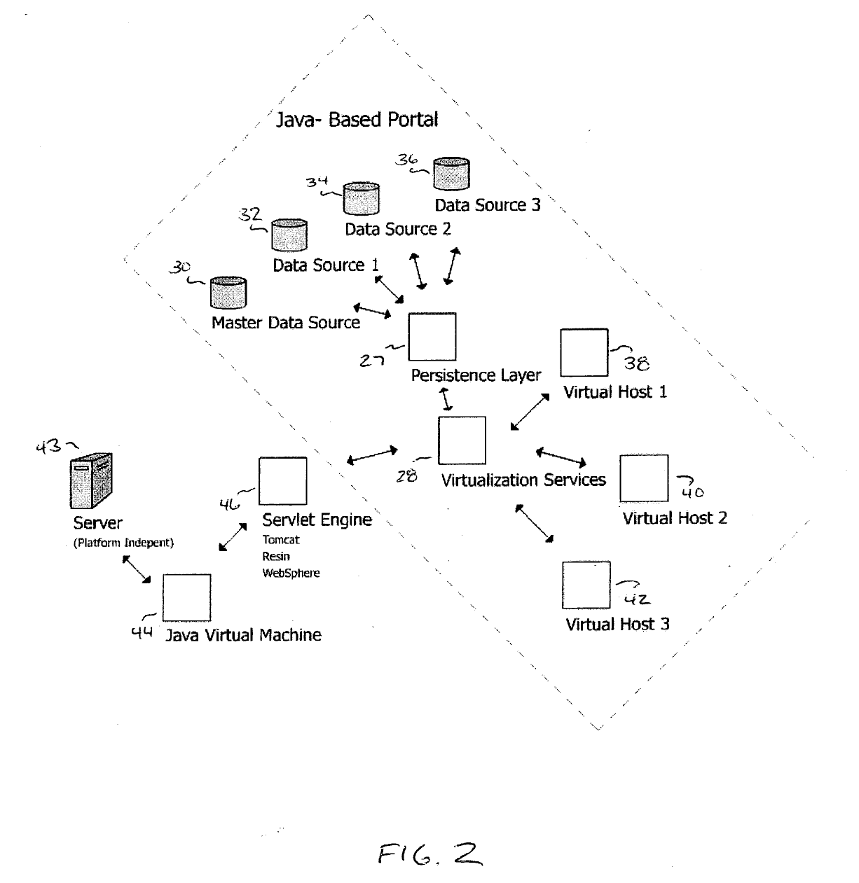

FIG. 2 illustrates an embodiment of the software architecture associated with the present architecture. Referring to FIG. 2, the invention includes a core infrastructure, including a component referred to herein as a persistence layer 27 that, among other things, receives commands from a user, requests objects from the data sources, and returns objects to the user in response to user commands. The persistence layer 27 may also perform functions, such as structured query language (SQL)-to-object conversion, wherein a command received in SQL is converted to an object that implements the command, such as by retrieving data from or sending data to a database, as well as transaction management, for example. The architecture may also include a virtualization layer 28 that determines which host should be used to service the user, and which database or databases should be made accessible to the user. Thus, multiple hosts such as 38, 40, and 42 and multiple data sources such as 30, 32, 34, and 36 are supported by a single application.

FIG. 2 also illustrates the architecture running on a server 43 that is equipped with supporting middleware, such as a Java virtual machine 44 and/or servlet engine(s) 46, such as Tomcat, Resin, and/or WebSphere, for example. However, the server and middleware are independent of the present invention, and thus other support systems may be used, as will be apparent to those skilled in the art.

The architecture may include multiple instances of the application software, and each instance may run on a separate server. For example, multiple virtual sites may be running on the same Servlet engine instance, within, for example, the same web application, accessing separate databases corresponded to the approved respective virtual hosts, or accessing a common database with the actual application data partitioned at the database level. Each virtual site may have its own branding, and each virtual site may be tied to a specific URL, i.e. server1.site1.com and server2.site2. com may both be tied to the same server on the same Servlet Engine instance within a web application, but may behave independently.

Each virtual site's data may preferably be completely partitioned from the other virtual sites, meaning that a user for server1 cannot log in to server2 and vise versa, unless the user is a member of a global Admin group, nor can individual users access data or applications from any of the other virtual sites. Within a virtual site, the security on data may be managed by the specific application code. For example, data security within a virtual site may be based on group affiliation, security rights, and/or the manner in which specific class implementers choose to handle security.

Thus, the virtualized architecture may segregate data at the database level by creating new partitions, i.e. table sets, for each Virtual Host. This may necessitate that a common schema exist that can be updated and replicated per the creation of a new Virtual Host, as discussed further hereinbelow with respect to administration groups. Virtualization further removes issues of maintaining users of the same username in different Virtual Hosts, as each Virtual Host may act on its data independently.

Tables B and C illustrate exemplary virtual host parameters and configurations that may be employed in the present invention.

TABLE B
Field

| | | | | | |
|---|---|---|---|---|---|
| Name | *Key | Description | Values | Business Rules | **Searchable |

| | | | |
|---|---|---|---|
| Virtualhost- | ▪ | The Unique ID | LONG INT |
| id | | | |
| Name | | Name of the virtual host | TEXT |
| url | | The URL associated with this | TEXT |
| | | virtual host | |
| Admingroupid | □ | The foreign key of the | LONG INT |
| | | accessor_group record representing | |
| | | the Admin group in this virtual | |
| | | host's set of tables | |
| Everyonegroupid | □ | The foreign key of the | LONG INT |
| | | accessor_group record representing | |
| | | the Everyone group in this virtual | |
| | | host's set of tables | |
| Primarydb- | □ | The foreign key of the db_config | LONG INT |
| configid | | record representing the default | |
| | | db_config instance | |

*Key: ▪ = Primary □ = Foreign
**Searchable: Y = Yes N = No

TABLE C
Field

| | | | | | |
|---|---|---|---|---|---|
| Name | *Key | Description | Values | Business Rules | **Searchable |

| | | | |
|---|---|---|---|
| paramid | ▪ | The unique ID for the parameter | LONG INT |
| name | | Name of the parameter | TEXT |
| value | | Value of the parameter | TEXT |
| virtual- | □ | The minimum number of | LONG INT |
| hostid | | connections available in the pool | |

*Key: ▪ = Primary □ = Foreign
**Searchable: = Yes N = No

Several hosts/portals, or all hosts/portals, may be accessed and/or managed by a “universal” administration module that may provide user, preference, community, group, application, and/or other types of management. Each instance may run multiple portals and support multiple data sources, and each instance preferably thereby ensures that each data source is only accessible to users who are assigned to that data source's associated portals/hosts. Thus, although the number of portals and data sources associated with each instance is not limited by software, the inventors recognize that hardware limitations, such memory space and processing capacity, may make it desirable to cause several instances of the application to run on multiple servers, either independent of each other, or linked through a communication network or system.

There may be at least two administration groups for the virtual site system that may access the administration module. Users who belong to the virtual site administrator group may have rights to create new users, groups, and communities, to control application data for that site, and may have the ability to assign rights on portal components to any users and groups within the virtual site. Thus, local and global administrative applications may have a set of screens for adding, updating, and deleting data configuration information per virtual site. However, one or several groups in a virtual site may be the local administrator of only a certain piece of functionality of that site, and local administrators may be subject to the maintaining of distinct partitions in the data between virtual sites.

A second administration group, as discussed hereinabove, may include a global administrative group, or groups. Within the database hierarchy may be a set of common tables that are used by the members of global administrative group for performing administrative functions, including virtual host administration, configuration information, and the management of applications in the overall system. Members of the global admin group may have the right to login to any virtual site, and, once entered, may have all rights to all data in the virtual site. Thus, global administrators have full privileges to all data in all systems, which may necessitate have a master login for all sites, or logins to each of the individual virtual sites. Global administrators may also have their own application data stored in a common way, to thereby allow access to their individual preferences, pidgets, applications, and application data from any of the virtual sites.

Global administrators may be provided with a listing of all virtual sites, and this listing may allow the creation, modification, and deletion of virtual sites, and may also allow access to edit configuration information of each of those virtual sites. Creation of a virtual site may include, for example, the providing of configuration information, a determining of the name of the virtual site's admin and user groups, registering any common navigation records that might change in a virtual site, and setting importing/synchronization of user data, among other functions.

Global, for the entire system, and local, for the unique virtual site, administrators may have the ability to view logs associated with the authorized virtual site correspondent to that administrator. The logs for each site may be written to a database, so that logs can be viewed via a web browser. Messages may be categorized per virtual site, including exceptions. Standard Java Logging API's are a piece of that logging framework.

Developer groups may register classes to the data source database(s), and a portal may manage the data source associations, thereby allowing developers to request the proper data source for a given class. In an embodiment, one and only one data source may be assigned as the default data source for a particular virtual site. That is the persistence data source for that site. An exemplary data source configuration table is given in Table D.

TABLE D
Field

| | | | | | |
|---|---|---|---|---|---|
| Name | *Key | Description | Values | Business Rules | **Searchable |

| | | | |
|---|---|---|---|
| Dbconfigid | ▪ | The Unique ID | LONG INT |
| Name | | Name of the configuration | TEXT |
| max_conns | | The maximum number of | INT |
| | | connections available in the pool | |
| min_conns | | The minimum number of | |
| | | connections available in the pool | |
| expire_time | | Expiration time in milliseconds | LONG INT |
| | | for unused Connections in pool | |
| clean_up | | Time in milliseconds between | LIONG INT |
| _time | | running the clean up procedure | |
| | | on the Connection pool | |
| wait_time | | Number of milliseconds to wait | LONG INT |
| | | for further requests when the | |
| | | Connection has no available | |
| | | Connections | |
| db_url | | URL of database, used for | TEXT |
| | | creating Connections | |
| db_login | | Username of database account | TEXT |
| | | that Connections will be created | |
| | | under | |
| db_pass | | Password of database account | TEXT |
| word | | that Connections will be created | |
| | | under | |
| Virtualhostid | □ | Virtual Host ID foreign key | LONG INT |

*Key: ▪ = Primary □ = Foreign
**Searchable: Y = YesN = No

It is desirable that developers, and particularly third party developers, have as little to learn about the system as possible. Thus, a Preferencable interface may be provided that allows preferences, a development and data storage mechanism for tightly coupled applications, to be accessible through standard methods, thereby abstracting developers from the complexity of the business logic in retrieving the correct preferences from the persistence.

An embodiment of the invention may use session management and Java Network and Directory interface (JNDI) services of the Java Servlet Engine to store modeling information that allows the persistence layer to store and access application data per virtual host data store. The virtualization modeling services may also allow business logic to access data sources related to the specific virtual host associated with the user's current virtual instance,

An embodiment may implement Model View Controller (MVC) architecture, and thus may use a navigation system that allows URL, navigation, and view resolution to be determined per virtual instance of the portal. This allows multiple pages to be referenced by the same handle, distinguished by virtual instance of the portal, thereby allowing customized branding and navigation of the portal infrastructure pages, such as Java Server Pages (JSPs).

An embodiment may also use JSP, Servlet, and JSP Tag Library technology to provide the basic building blocks of the portal screens, thereby allowing customization of user interface without altering business logic functionality in the portal. The invention may also provide one or more layers of existing or custom network application integration tools, allowing varying levels of integration.

In a specific illustrative embodiment of the present invention, a model may act as the proxy to the actual persistence of the desired data. Updates and retrievals may be performed through requests made of the model. A view may leave application flow to a controller, and data access and persistence to the model. The controller may serve as the “brain”. For example, navigation logic may be routed through the controller, and the controller may determine the model changes necessary, as well as the next view to present, in a given application. In this exemplary embodiment, the use of cached models for oft-accessed data, such as style, preferences, layout, security information, and the like may improve performance by returning to the persistence for only less common application data, such as a request to view Document X.

In an exemplary embodiment of this specific illustration, the view may be handled by a JSP that processes outputting the data into formatted HTML, or other web-based text format, for example. In an exemplary embodiment, as much of the business logic as is possible may be left to tag libraries that are called within the JSP(s), and as little scriptlet code as is possible may be used in the JSP(s), thereby avoiding the duplication of business logic, and allowing front-end designers to access data without affecting data operation.

In this exemplary embodiment, a control servlet may serve as the controller. This control servlet may handle the routing of requests for functionality to the proper JSP, based on several factors, such as the requesting of a session's virtual host, which use of the session virtual host allows for a different navigation pattern for each virtual host). The control servlet may determine, based on these factors, the JSP that will be executed, and thus the business logic (in the form of tag libraries, for example) that may be called.

At a base level, the user may be provided with the ability to perform a single sign-on into a third party web-based application. The architecture allows the registration of a third party application and the declaration of the parameters necessary to access the system. The portal may collect and encrypt the credentials from the requesting user and attempt the single sign-on process. This may also allow the user or network administrator to manage and modify the credentials of a given user into a single sign-on. This effectively allows the central management of user logins to multiple web-based applications through the portal. This base level may be managed by application, role-based security access of a given user within a given virtual instance of the portal.

Third party integration of applications may also be available through a set of Java interfaces that, when implemented and registered with the portal, may allow multiple portal services to be performed and accessed on a third party application. One example of such an interface is that known as Searchable. The Searchable interface allows a portal search tool to search, retrieve, and access the data of multiple objects, both internal and external to the portal, through a single user interface. Third party objects may become a part of a workflow process, or be presented as a user's calendar event by implementing new interfaces on their data.

For organizations desiring to extend the functionality of a portal, the present invention may provide, through the portal or portals, business object, persistence, and virtualization services, allowing Java or other applications to be written that will transparently interact with a virtualized environment. These business object and persistence services may utilize, for example, Java Database Connectivity (JDBC), Servlet, Extensible Markup Language (XML) and/or other technologies to persist and retrieve data within a virtualized environment.

In accordance with an embodiment, wrapping the levels of integration is a virtualized application role-based security. This system allows network applications to be associated with specific virtual portal instances, as well as the assignment of users and groups to roles within each application, per virtual portal instance, This ensures that a user who is authenticated against a specific virtual portal instance only has access to the applications and application components that are assigned to that user's virtual portal instance, and to which that user or that user's group(s) have been given rights.

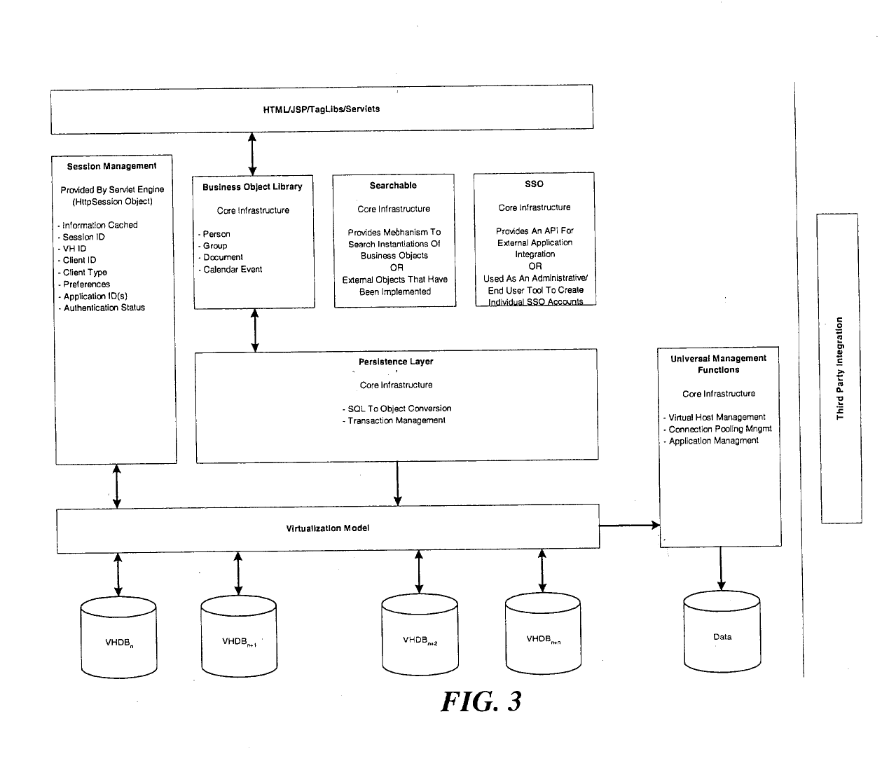

FIG. 3 is a block diagram illustrating the interrelation of the services described hereinabove. Using an architecture as shown in FIG. 3, the present invention may enable a portal provider to reduce the cost of deployment through efficient use of memory and processing capacity. The virtualized model may support a single “instance” of the application software, while supporting multiple business units or customers. In other words, rather than installing multiple instances of the application of a single server, a single instance may support multiple virtual hosts. The result is that server requirements may be reduced for a single server deployment, or the number of required servers may reduced in a multi-platform environment, for example.

In addition, virtualization as embodied in the present invention may enable a portal provider to accommodate a broader user base via a single instance of the software. In accordance with the prior art, an Internet Service Provider (ISP) or enterprise customer would be required to install a single instance of the portal for each customer or business unit that required a unique interface, navigation services, and data storage services. With virtualization in place, a single deployment of an application could potential may support a large User population.

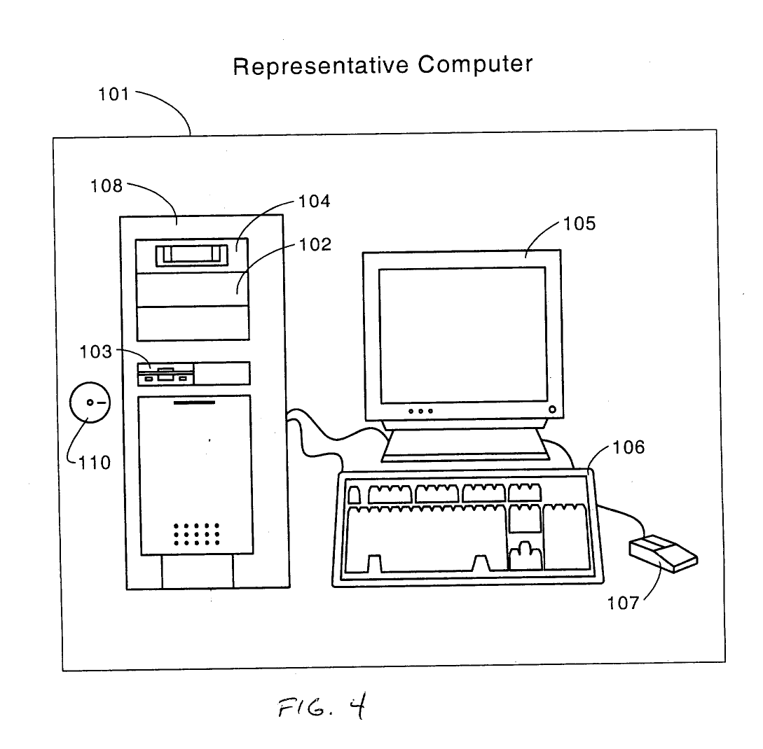

The present invention may be run on, or may include, a server or other computer and associated equipment and/or media, Viewed externally in FIG. 4, an exemplary computer system 101 includes a central processing unit located within a housing 108 and disk drives 103 and 104. Disk drives 103 and 104 are merely symbolic of a number of disk drives which might be accommodated by the computer system. Typically these would include a hard disk drive and optionally one or more floppy disk drives, such as 103 and/or one or more CD-ROMs, CD-Rs, CD-RWs or digital video disk (DVD) devices indicated by slot 104. The number and types of drives typically varies with different computer configurations. Disk drives 103 and 104 are in fact options, and may be omitted from the computer system used in connection with the processes described herein. An exemplary storage medium 110, which is one type of carrier that may contain prograll1 instructions and/or data, is also illustrated. Additionally, a computer system utilized for implementing the present invention may be a stand-alone computer having communications capability, a computer connected to a network or able to communicate via a network, a handheld computing device, or any other form of computing device capable of carrying out equivalent operations.

The computer also has, or is connected to, or delivers signals to, a display 105 upon which graphical, video and/or alphanumeric information is displayed. The display may be any device capable of presenting visual images, such as a television screen, a computer monitor, a projection device, a handheld or other microelectronic device having video display capabilities, or even a device such as a headset or helmet worn by the user to present visual images to the user's eyes. The computer may also have or be connected to other means of obtaining signals to be processed. Such means of obtaining these signals may include any device capable of receiving images and image streams, such as video input and graphics cards, digital signal processing units, appropriately configured network connections, or any other microelectronic device having such input capabilities.

An optional keyboard 106 and/or a directing device 107, such as a remote control, mouse, joystick, touch pad, track ball, steering wheel, remote control or any other type of pointing or directing device, may be provided as input devices to interface with the central processing unit.

FIG, 5 illustrates a block diagram of the internal hardware of the computer of FIG. 4. A bus 256 serves as a main information pathway interconnecting the other components of the computer. CPU 258 is the central processing unit of the system, performing calculations and logic operations required to execute a program. Read only memory (ROM) 260 and random access memory (RAM) 262 constitute the main memory of the computer.

A disk controller 264 interfaces one or more disk drives to the system bus 256, These disk drives may be external or internal floppy disk drives such as 270, external or internal CD-ROM, CD-R, CD-RW or DVD drives such as 266, or external or internal hard drives 268 or other many devices. As indicated previously, these various disk drives and disk controllers are optional devices.

Program instructions may be stored in the ROM 260 and/or the RAM 262. Optionally, program instructions may be stored on a computer readable carrier such as a floppy disk or a digital disk or other recording medium, flash memory, a communications signal, and/or a carrier wave.

A display interface 272 permits information from the bus 256 to be displayed on the display 248 in audio, graphic or alphanumeric format. Communication with external devices may optionally occur using various communication ports such as 274.

In addition to the standard components of the computer, the computer also includes an interface 254 that allows for data input through the keyboard 250 or other input device, and/or through the directional or pointing device 252 such as a remote control, pointer, mouse or joystick.

It is to be understood that the invention is not limited in its application to the details of construction and to the arrangements of the components set forth herein or illustrated in the drawings. The invention may include modifications and variations not specifically discussed herein, but apparent to those skilled in the art in light of the disclosure herein. Also, it is to be understood that the phraseology and terminology employed herein are for the purpose of description, and should not be regarded as limiting. Thus, the present invention includes the construction and operation herein illustrated and described, and all appropriate modifications and variations that may fall within the scope of the disclosure and drawings referred to herein, the claims appended hereto, and the equivalents thereof.

What is claimed is:

1. A method of managing data for a plurality of users, comprising:
maintaining, in a computer memory, a plurality of databases that each comprise user access data;
providing at least one network portal supported by a plurality of virtual hosts;
receiving a user identification from at least one of the plurality of users;
selecting, based on the received user identification, from the plurality of virtual hosts, a selected virtual host to uniquely present the portal to the user; and
identifying, in accordance with the selected virtual host, from the plurality of databases, at least one authorized database accessible to the user, wherein the user is excluded from access to unauthorized databases associated with unselected ones of the virtual hosts.

2. The method of claim 1, wherein said identifying is further in accordance with a role of the user.

3. The method of claim 1, wherein the user identification comprises a network address.

4. The method of claim 1, wherein said identifying further comprises identifying at least one accessible application associated with the at least one authorized database.

5. The method of claim 1, further comprising providing a central administrator in communication with each of the virtual hosts.

6. The method of claim 1, further comprising providing one local administrator in communication with each of the virtual hosts.

7. A networked data management system including a plurality of databases, a plurality of virtual portal hosts, and a central support layer in communication with each of the virtual portal hosts and each of the databases, comprising:
computer program instructions that, when executed by a computer processor in the central support layer, cause the computer processor to execute the steps of:
maintaining, in a computer memory associated with the computer processor, a plurality of databases that each comprise user access data;
receiving a user identification in the central support layer from at least one of a plurality of users;
selecting, based on the received user identification, from the plurality of virtual portal hosts, a selected virtual portal host to uniquely present the portal to the user correspondent to the user identification; and
identifying, in accordance with the selected virtual portal host, from the plurality of databases, at least one authorized database accessible to the user.

8. The networked data management system of claim 7, wherein the plurality of virtual portal hosts support a single portal.

9. The networked data management system of claim 8, wherein each of the plurality of virtual portal hosts uniquely prevents the single portal to the user of that virtual portal host.

10. The networked data management system of claim 7, wherein the user identification comprises one selected from the group consisting of an administrator and a non-administrator.

11. The networked data management system of claim 10, wherein the administrator comprises one selected from the group consisting of a local administrator and a global administrator.

12. The networked data management system of claim 11, wherein the local administrator comprises a communication with a single one of the virtual portal hosts.

13. The networked data management system of claim 11, wherein the global administrator comprises a communication with all of the plurality of virtual portal hosts.

14. The networked data management system of claim 10, wherein the user identification further comprises a role of the user.

15. The networked data management system of claim 14, wherein the user identification further comprises a network address.

16. The networked data management system of claim 7, further comprising at least one accessible application associated with the at least one authorized database.

17. A networked data management system, comprising:
a plurality of databases that each comprise user access data associated with a single portal;
a plurality of virtual portal hosts communicatively connected to the single portal; and
a central support layer in communication with each of the virtual portal hosts and each of the databases;
wherein a user identification is received in the central support layer from at least one of a plurality of users, and wherein, based on the received user identification, one of the virtual portal hosts is selected by the central support layer to uniquely present the single portal and selected ones of the plurality of databases to the user correspondent to the user identification, in accordance with the user identification.

18. The networked data management system of claim 17, wherein the user identification comprises one selected from the group consisting of a local administrator and a global administrator.

19. The networked data management system of claim 17, wherein the user identification comprises a role of the user and a network address.

20. The networked data management system of claim 17, further comprising at least one accessible application associated with the selected ones of the plurality of databases.
